(19) United States
(12) Patent Application Publication
(10) Pub. No.: US 2019/0066659 A1
(43) Pub. Date: Feb. 28, 2019

(54) DIALOGUE CONTROL SYSTEM AND DIALOGUE CONTROL METHOD

(71) Applicant: FUJITSU LIMITED, Kawasaki-shi (JP)

(72) Inventors: Takashi Imai, Atsugi (JP); Tatsuro Matsumoto, Yokohama (JP); Miwa Okabayashi, Sagamihara (JP)

(73) Assignee: FUJITSU LIMITED, Kawasaki-shi (JP)

(21) Appl. No.: 16/103,313

(22) Filed: Aug. 14, 2018

(30) Foreign Application Priority Data
Aug. 23, 2017 (JP) 2017-160272

(51) Int. Cl. G10L 15/06; G10L 25/63; G10L 15/22; G06Q 30/02

(52) U.S. Cl. CPC G10L 15/063; G10L 25/63; G10L 15/22; G10L 2015/0638; G10L 2015/225; G10L 2015/223; G06Q 30/0257

(57) ABSTRACT

A dialogue control system includes a memory, and a processor coupled to the memory and the processor configured to select, from a supplementary information candidate, supplementary information related to at least one of a past context of an interaction including an input from a user and a predetermined output of the dialogue control system with respect to the input from the user, an input of the user expected in future in association with the output of the dialogue control system, and an output of the dialogue control system scheduled in the future, and insert the selected supplementary information into the interaction and present the inserted supplementary information to the user.

### CROSS-REFERENCE TO RELATED APPLICATION

This application is based upon and claims the benefit of priority of the prior Japanese Patent Application No. 2017-160272, filed on Aug. 23, 2017, the entire contents of which are incorporated herein by reference.

### FIELD

The embodiments discussed herein are related to a dialogue control system and a dialogue control method.

### BACKGROUND

In the related art, there is a technique of distributing an advertisement to a user while the user is browsing contents.

For example, as an example of a technique for distributing an advertisement, there is a technique that extracts a word, a character string, or data of a specific size that may be a keyword from various data that are being transmitted and received, and searching advertisement information registered in an advertisement information storing system with the extracted keyword as a search condition. When registration information satisfying a specific condition is searched, the searched advertisement/information data is extracted, the advertisement/information data is inserted into the data to be transmitted, and based on the inserted data, advertisement/information is distributed to reception clients.

There is a technique for providing a service related to a keyword of dialogue contents on a display device. The display device acquires the keyword included in the dialogue contents of a mobile device and displays additional information corresponding to the keyword to implement the provision of the service.

There is a technique for presenting the advertisement according to a situation of a consumer (user). In the technique, a system collects situation information related to the consumer and determines a current action and a future behavior involved by the consumer based on the situation information. Thereafter, the system predicts one or more advertising opportunities that occur closely to the consumer based on the determined behavior, and presents the predicted opportunities to one or more advertisers. Thus, the advertiser may determine a total bid amount for presenting the advertisement at the predicted opportunity. The system also selects at least one advertisement to be presented based on at least one of the total bid amount, the collected situation information, an occurrence probability of the predicted advertising opportunity, contents of the advertisement, and metadata related to the advertisement. The system then presents the selected advertisement to the consumer.

Related techniques are disclosed in, for example, International Publication Pamphlet No. WO2006/028213, and Japanese Laid-Open Patent Publication Nos. 2013-258699 and 2012-108910.

### SUMMARY

According to an aspect of the invention, a dialogue control system includes a memory, and a processor coupled to the memory and the processor configured to select, from a supplementary information candidate, supplementary information related to at least one of a past context of an interaction including an input from a user and a predetermined output of the dialogue control system with respect to the input from the user, an input of the user expected in future in association with the output of the dialogue control system, and an output of the dialogue control system scheduled in the future, and insert the selected supplementary information into the interaction and present the inserted supplementary information to the user.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a scenario of a dialogue in a recipe application;

FIG. 2 is a diagram illustrating an example of a case where an advertisement that does not conform to a context of the dialogue is presented by the recipe application;

FIG. 3 is a diagram illustrating an example of a case where the advertisement that conforms to the context of the dialogue is presented by the recipe application;

FIG. 4 is a block diagram illustrating a schematic configuration of a dialogue control system according to a first embodiment of the present disclosure;

FIG. 5 is a block diagram illustrating a configuration of a dialogue control device according to the first embodiment of the present disclosure;

FIG. 6 is a diagram illustrating an example of the scenario of the dialogue;

FIG. 7 is a diagram illustrating an example of data stored in a scenario context word candidate storage unit;

FIG. 8 is a diagram illustrating an example of data stored in a meta information context word candidate storage unit;

FIG. 9 is a diagram illustrating an example of data stored in a context word-specific user reaction information storage unit;

FIG. 10 is a block diagram illustrating a schematic configuration of a computer serving as a dialogue control device;

FIG. 11 is a flowchart illustrating an example of a dialogue control process according to the first embodiment of the present disclosure;

FIG. 12 is a block diagram illustrating a schematic configuration of a dialogue control system according to a second embodiment of the present disclosure;

FIG. 13 is a block diagram illustrating a configuration of a dialogue control device according to the second embodiment of the present disclosure;

FIG. 14 is a diagram illustrating an example of a table configuration of an advertisement selection effect history DB; and

FIG. 15 is a flowchart illustrating an example of a dialogue control process according to the second embodiment of the present disclosure.

### DESCRIPTION OF EMBODIMENTS

There is a case where when contents are provided by an interaction (dialogue) indicating an exchange of information between a user and a system, an advertisement or information which does not conform to a context of the interaction is presented in the related art.

First, a technology which becomes a premise of an embodiment will be described.

There is a dialogue system that performs an interactive dialogue between the user and the system. As such a service, services such as a messenger, chatting, and a voice dialogue are provided.

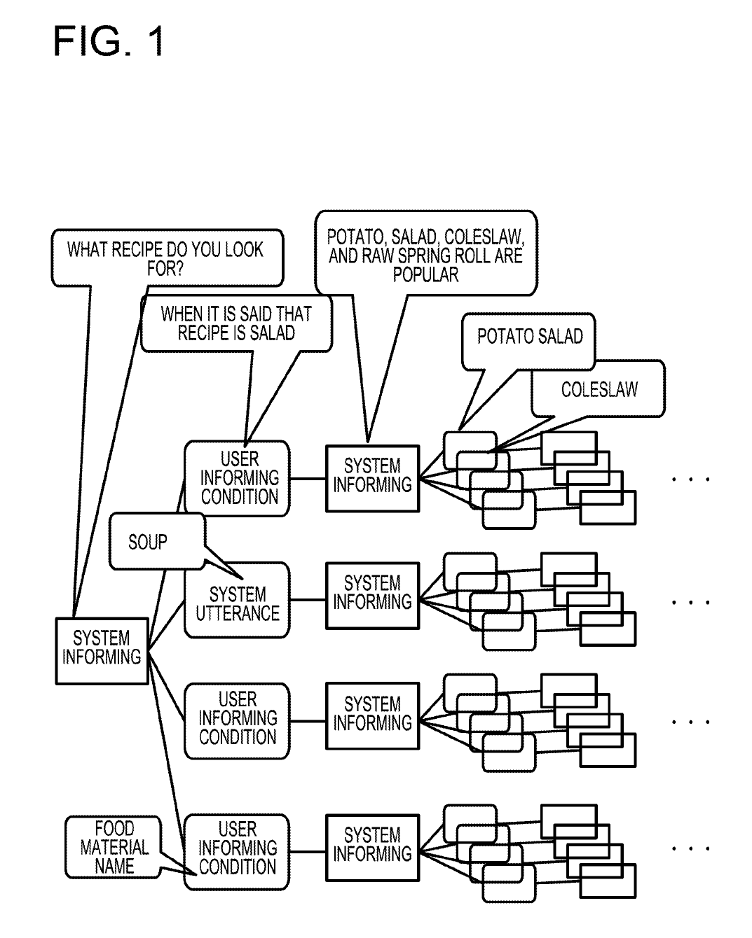

As an example of such an interactive service, a scenario of the dialogue is prepared in advance and the dialogue progresses according to the scenario. FIG. 1 illustrates an example of the scenario of the dialogue of an application that searches a recipe (hereinafter, referred to as a “recipe application”).

As illustrated in FIG. 1, in the recipe application, first, in a system informing, a proposal is given to the user by the system as to “what recipe do you look for?” Next, it is determined whether an informing of the user to the proposal matches a user informing condition prepared in advance in the scenario. The user informing condition is a word or the like related to a content expected to be informed by the user in progressing the scenario with respect to the system informing. In the case of the recipe application, for example, “salad”, “soup”, “food ingredient name”, and the like may be set as the user informing condition for “What kind of recipe do you look for?” Then, the system informing associated with the matched user informing condition is made. For example, when the informing of the user matches the “salad” of the user informing condition, a system informing such as “potato salad, coleslaw, and raw spring roll are popular” which is associated with the user informing condition “salad” is performed. As described above, a dialogue-type service that progresses the dialogue according to the scenario may be provided.

Herein, in a dialogue-type service in which the user and the system interact with each other, a case is considered as an example where an advertisement is inserted during an interaction.

As a technique for distributing an advertisement, there is a technique in which the advertisement is distributed to a user based on information related to the contents and information related to the advertisement while the user is browsing the contents. In the case of the contents, since the contents are known in advance, an appropriate advertisement may be inserted into a point where the advertisement may be inserted in advance.

Meanwhile, in the dialogue-type service, it is desirable to insert and present the advertisement that conforms to the context of the dialogue. In other words, it is necessary to control the service such that an advertisement which does not conform to the context of the dialogue is not inserted.

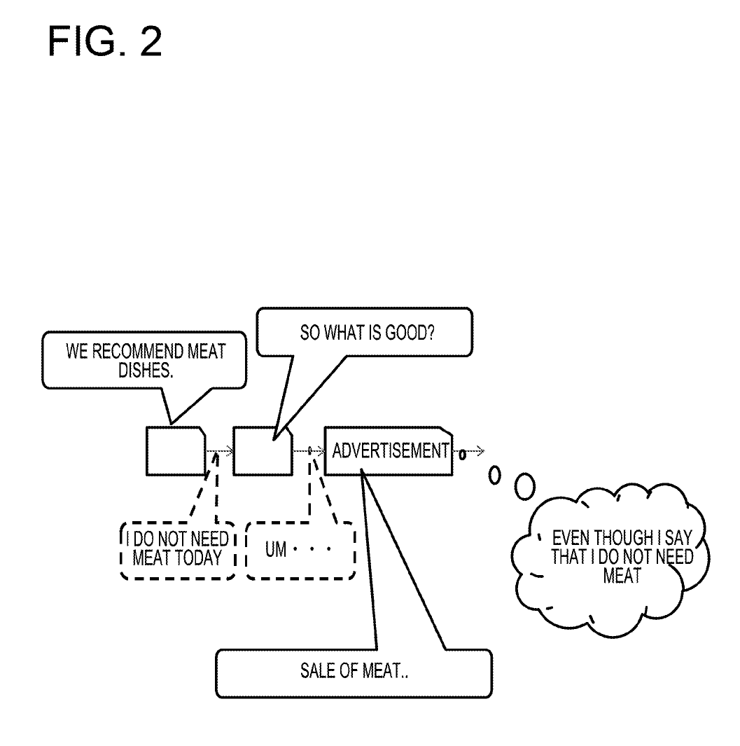

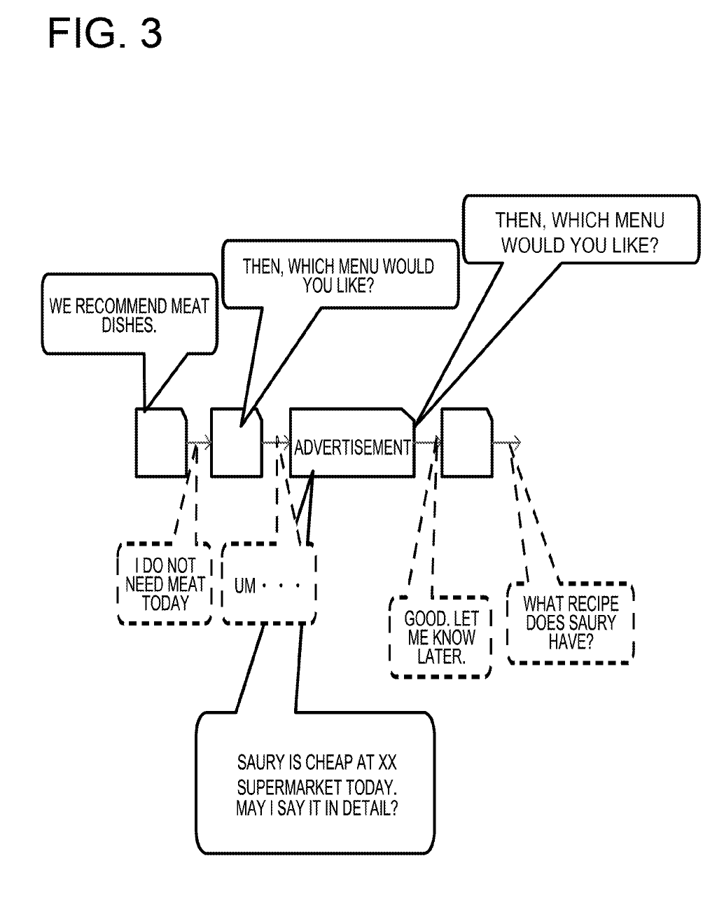

FIG. 2 illustrates an example of a case where an advertisement that does not conform to the context of the dialogue is presented in a recipe application. Further, in FIG. 2, a system informing is represented by a chat bubble of a solid line and a user informing is represented by a chat bubble of a broken line. This also applies to FIG. 3 described below. As illustrated in FIG. 2, a user informs that “the meat is not needed today” against a proposal that “meat dish is recommended” in the system informing. In this regard, the system informing informs a question saying “What is good then” and the user informs a speech that defers a determination such as “um . . . ”. In this manner, it is conceivable that the insertion of the advertisement is performed at the timing when the informing of the user does not match the user informing condition prepared as a scenario, and the progress of the dialogue is interrupted or the like. Herein, the inserted advertisement is the content of “meat selling at bargain . . . ”, but because the user informs that “I do not need meat today” in the dialogue, the inserted advertisement is an advertisement that does not conform to the context of the dialogue. Even for an advertisement related to a keyword appearing in the informing of the user, it is necessary to control the service such that an advertisement that does not conform to an intention of the user is not inserted.

FIG. 3 illustrates an example of a case where an advertisement that conforms to the context of the dialogue is presented in the recipe application. In the example of FIG. 3, the same dialogue progresses as in the case of FIG. 2 and as the advertisement, an advertisement with contents saying “Saury is cheap at XX supermarket today. May I say it in detail?” is inserted. In regard to the advertisement, the user informs that “Good, let me know later” and the dialogue is progressing according to the content presented in the advertisement.

Hereinafter, one example of an embodiment of the present disclosure will be described in detail with reference to the accompanying drawings. In the embodiment, a dialogue control system for presenting the advertisement according to the context of the dialogue will be described as an example. In addition, in the embodiment, the advertisement is an example of supplementary information of the disclosed technique. Further, the supplementary information in the embodiment is information other than information output from the system according to the scenario in the interactive service.

### First Embodiment

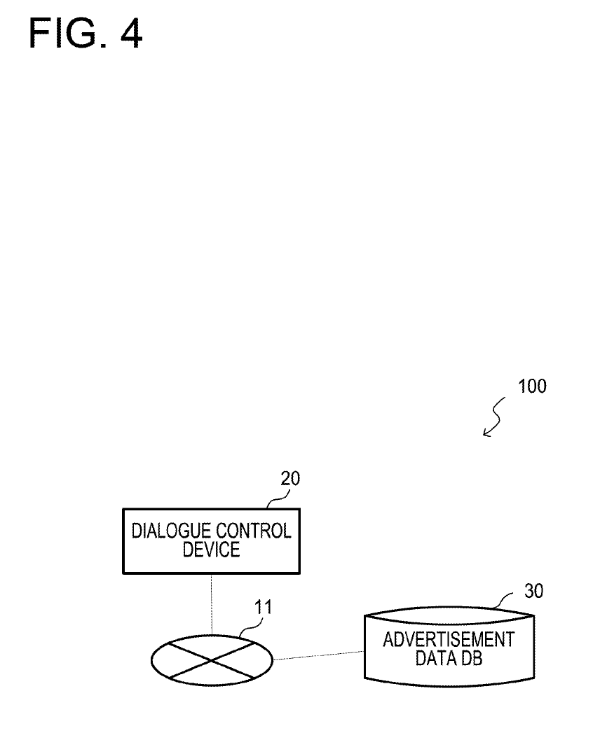

First, a first embodiment of the present disclosure will be described. As illustrated in FIG. 4, a dialogue control system 100 according to the embodiment includes a dialogue control device 20 and an advertisement data DB 30. The dialogue control device 20 and the advertisement data DB 30 are connected with each other via a network 11 such as the Internet.

The dialogue control device 20 progresses an exchange of the dialogue between the user and the system according to the scenario. Further, the dialogue control device determines whether the advertisement is inserted in the progress of the dialogue, selects the advertisement depending on the context of the dialogue, and presents the advertisement to the user when the advertisement is inserted. Further, the exchange of the dialogue is an example of the interaction.

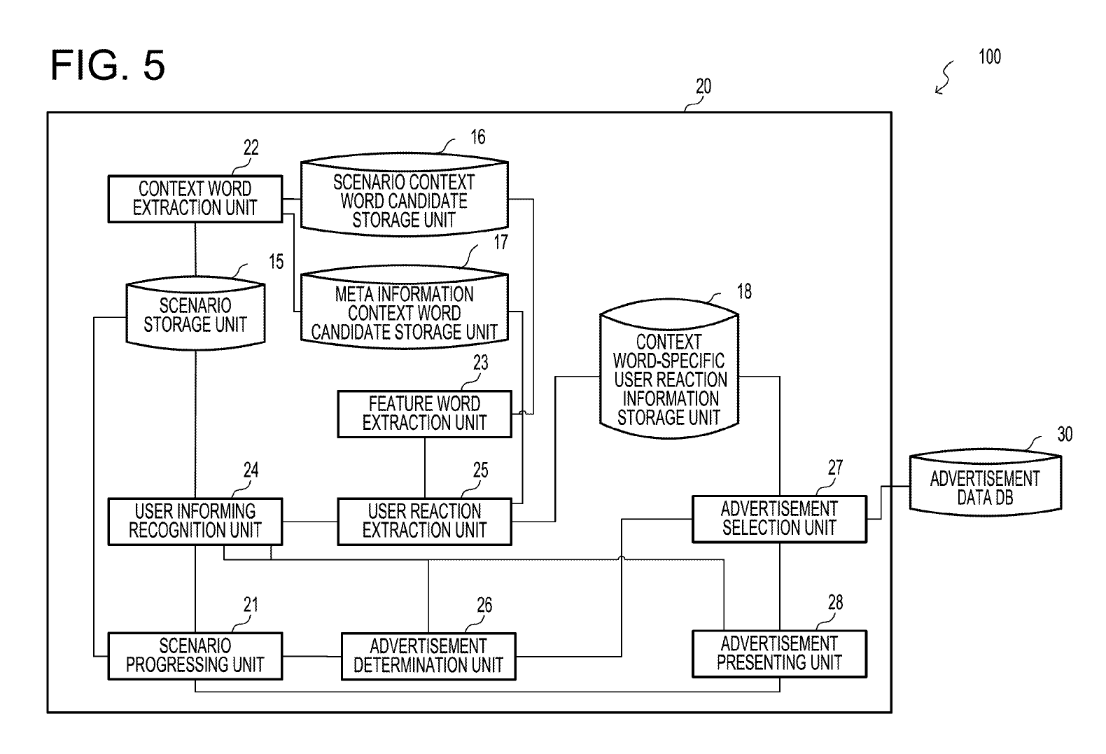

As illustrated in FIG. 5, the dialogue control device 20 is configured to include a scenario storage unit 15, a scenario context word candidate storage unit 16, a meta information context word candidate storage unit 17, and a context word-specific user reaction information storage unit 18. Further, the dialogue control device 20 is configured to include a scenario progressing unit 21, a context word extraction unit 22, a feature word extraction unit 23, a user informing recognition unit 24, a user reaction extraction unit 25, an advertisement determination unit 26, an advertisement selection unit 27, and an advertisement presenting unit 28. In addition, the user reaction extraction unit 25 is an example of an extraction unit of the disclosed technique. The advertisement determination unit 26 is an example of a determination unit of the disclosed technique. The advertisement selection unit 27 is an example of a selection unit of the disclosed technique. The advertisement presenting unit 28 is an example of a presenting unit of the disclosed technique.

In the advertisement data DB 30, an advertisement to be selected and attribute information related to the advertisement are stored. The attribute information is, for example, information such as a keyword and a genre set by an advertiser, a keyword extracted from an advertisement informing text, a time zone for presenting the advertisement, a target age, a gender, a region, and the like. Further, the advertisement may be provided with a detailed advertisement for presentation in a case where the user shows a reaction of wanting to know more detailed contents of the advertisement. For example, when the advertisement is “Today is a special sale day of fish at XX supermarket”, a detailed advertisement such as “The price of a saury is XXX Yen, the price of a saurel is XXX YEN . . . ” is provided, so that the advertisement may be presented in a step-by-step manner according to the reaction of the user. In addition, each advertisement to be selected is an example of a supplementary information candidate of the disclosed technique.

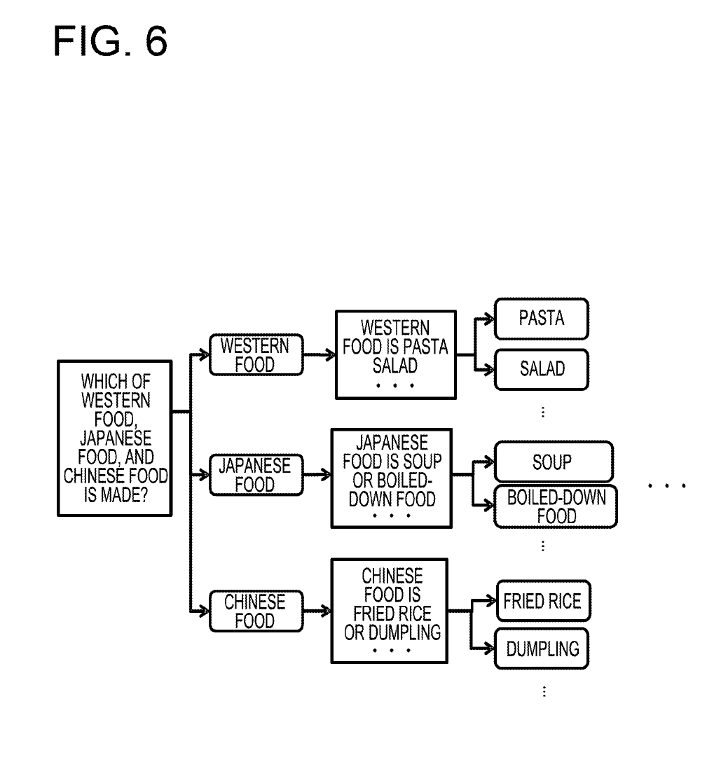

The scenario storage unit 15 stores the scenario of the dialogue between the user and the system. In the scenario, as illustrated in FIG. 6, a first set is that one first system informing is performed and a plurality of user informing conditions related to the user informing is associated with the first system informing. In addition, there is a next second set of the system informing for the first set of the plurality of user informing conditions and the plurality of user informing conditions for the system informing. The scenario has a configuration in which the set of the system informing and the plurality of user informing conditions are continued in a tree shape to be hierarchically branched. FIG. 6 illustrates an example of a scenario in which recipe searching is a subject matter and the first system informing is “Which of Western food, Japanese food, and Chinese food is made?” and the scenario informing includes a plurality of user informing conditions such as “Western food”, “Japanese food”, and “Chinese food”. Further, the scenario itself or meta information regarding a word appearing in the scenario is given to the scenario. As the meta information on the recipe search scenario, for example, keywords necessary for recommending recipes such as “hot”, “cold”, “child”, “anniversary”, “easy”, and the like may be cited.

Upon receiving an instruction to start the dialogue from the user, the scenario progressing unit 21 acquires the scenario from the scenario storage unit 15, starts the dialogue, and speaks the first system informing to the user, thereby starting the progression of the dialogue. The instruction to start the dialogue is a greeting from the user, an input of predetermined informing, activation of the recipe application, the input of a predetermined command, or the like. Further, upon receiving an instruction to progress the scenario from the advertisement determination unit 26, the scenario progressing unit 21 selects the system informing corresponding to the user informing condition matched in a determination result immediately before the user informing recognition unit 24, and gives the system informing to the user and progresses the dialogue. In addition, the system informing depending on the scenario is an example of an output of a predetermined system of the disclosed technique.

When the dialogue is started by the scenario progressing unit 21, the context word extraction unit 22 acquires the scenario of the started dialogue from the scenario storage unit 15. Then, the context word extraction unit 22 extracts a word which may appear in the dialogue as a context word candidate from the system informing included in the acquired scenario and the plurality of user informing conditions, and stores the corresponding word in the scenario context word candidate storage unit 16. When the system informing is a sentence, the context word candidate may be extracted by performing a morpheme analysis as necessary. Further, the context word extraction unit 22 extracts the context word candidate from the meta information attached to the selected scenario and stores the extracted context word candidate in the meta information context word candidate storage unit 17. In addition, the context word is a word which may appear in the context of the dialogue between the user and the system and the context word candidate is a word which may be the context word in the dialogue between the user and the system.

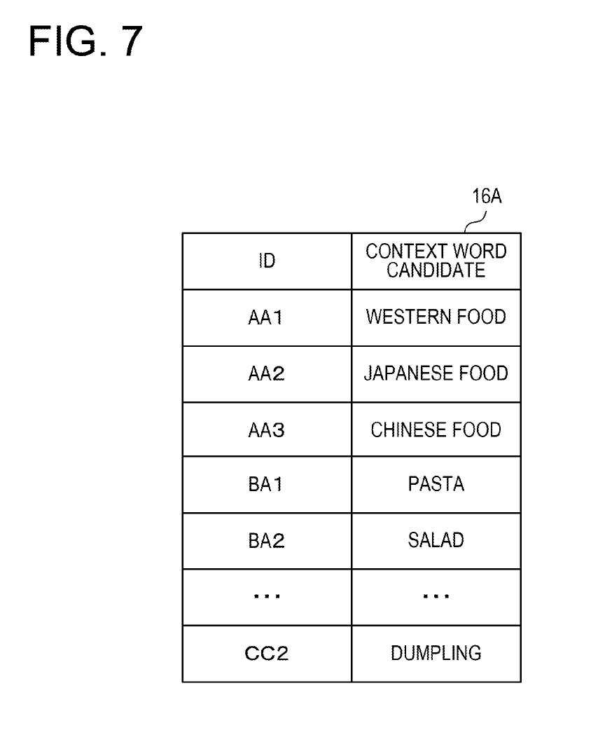

The scenario context word candidate storage unit 16 stores the context word candidate extracted from the scenario by the context word extraction unit 22. FIG. 7 illustrates an example of a context word candidate 16A stored in the scenario context word candidate storage unit 16. Items of a table of the context word candidate 16A are constituted by an ID for identifying the context word candidate and the context word candidate. A first record stores a context word candidate “format” corresponding to ID “AA1”.

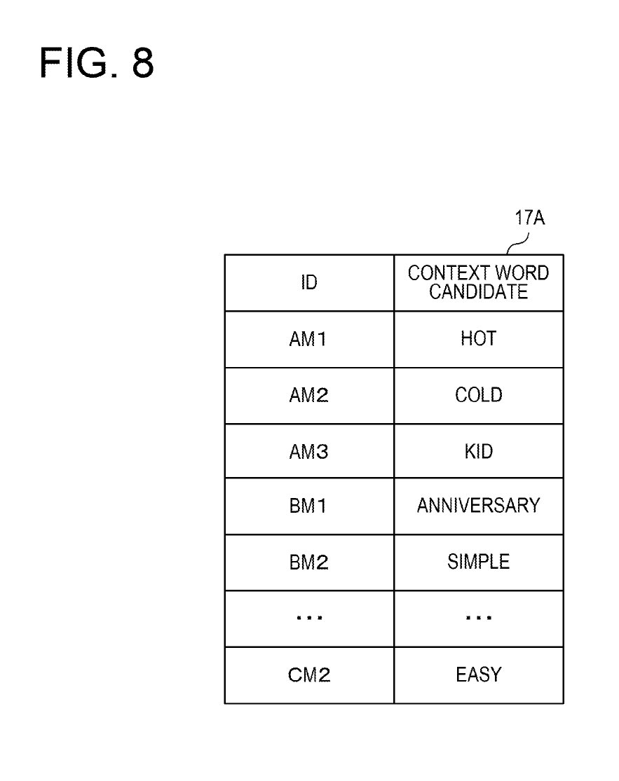

The meta information context word candidate storage unit 17 stores the context word candidate extracted from the meta information of the scenario by the context word extraction unit 22. FIG. 8 illustrates an example of the context word candidate 17A stored in the meta information context word candidate storage unit 17. The items of the table of the context word candidate 17A are constituted by the ID for identifying the context word candidate and the context word candidate. The first record stores a context word candidate “hot” corresponding to ID “AM1”.

The feature word extraction unit 23 extracts a feature word each time the dialogue is made by the scenario progressing unit 21 and the system informing is given. The feature word extraction unit 23 extracts the candidate word candidate matching the word included in the system informing from the context word candidate stored in the scenario context word candidate storage unit 16 and the meta information context word candidate storage unit 17 as the feature word of the system. In addition, the extracted feature word is output to the user reaction extraction unit 25. Further, the feature word extraction unit 23 extracts context word candidates that match words included in the plurality of user informing conditions related to the user informing for the given system informing as the feature word. In addition, the feature word extraction unit 23 may extract system informing scheduled after the plurality of user informing conditions related to the user informing for the given system informing as the feature word. Moreover, the feature word extraction unit 23 may extract the context word candidates that match the words included in the plurality of user informing conditions related to the user informing for the system informing as the feature word. As described above, by extracting the feature word relating to the scheduled system informing and the user informing condition, a word that is likely to be informed in the future may be taken as the feature word.

The user informing recognition unit 24 speech-recognizes the user informing which is a response of the user to the system informing to acquire text data indicating the user informing. For example, the user informing recognition unit 24 extracts a predetermined important word, a word indicating a predetermined informing intention, such as a question, an evaluation word indicating a positive or negative evaluation, and the like from a word obtained through a morphological analysis of text data indicating the user informing, and outputs the extracted word to the user reaction extraction unit 25 as a recognition result. Further, the user informing recognition unit 24 determines whether the word included in the user informing is an evaluation word, for example, based on an evaluation word dictionary in which the evaluation word corresponds to polarity information indicating whether the evaluation word is a word indicating the positive evaluation or a word indicating the negative evaluation. In addition, the user informing recognition unit 24 adds the polarity information of the word to the word determined as the evaluation word to include the added polarity information in the recognition result. The user informing recognition unit 24 determines whether any one word included in the recognition result matches one of the plurality of user informing conditions at a current point of time in the scenario and outputs a determination result to the advertisement determination unit 26. In addition, the user informing recognition unit 24 receives, from the advertisement presenting unit 28, a notification indicating that there is a detailed advertisement in the advertisement presented to the user. Upon receiving the notification indicating that there is the detailed advertisement, the user informing recognition unit 24 returns to the advertisement presenting unit 28 the recognition result as to whether the user informing is requested to present the detailed advertisement. Further, the user informing is an example of an input from the user of the disclosed technique.

The user reaction extraction unit 25 sets the feature word extracted by the feature word extraction unit 23 as the context word. Further, among the context words, a context word which is the feature word as the word included in the system informing and matches the word included in the recognition result of the user informing output from the user informing recognition unit 24 may be identified by a method of granting the ID granted to the context word. The context word is made identifiable because the context word is a word indicating a positive response of the user to the system informing in the dialogue. Therefore, the context word may be identified and processing such as handling the context word as an important word in later advertisement selection is made possible. Further, the user reaction extraction unit 25 extracts the candidate word candidate matching the word included in the recognition result of the user informing as the context word from the context word candidates stored in the scenario context word candidate storage unit 16 and the meta information context word candidate storage unit 17. The user reaction extraction unit 25 evaluates the reaction of the user to the extracted context word based on the recognition result of the user informing and stores the evaluated reaction in the context word-specific user reaction information storage unit 18. The evaluation of the reaction of the user is made by distinguishing the evaluation into two types, the positive reaction and the negative reaction. Further, a word which may not be evaluated is left unevaluated. In addition, the evaluation may be made by providing another distinguishment other than the positive reaction and the negative reaction.

Examples of the extraction of the context word and the evaluation of the reaction of the user to the context will be described below.

For example, “Western food”, “Japanese food”, and “Chinese food” are extracted as the context words from the system informing “Which one of Western food, Japanese food, and Chinese food is made?” In this regard, it is assumed that the user informing is “dislike Chinese food” and the word of the recognition result includes “Chinese” and “dislike”. Further, it is assumed that the polarity information indicating that the “dislike” is the word indicating the negative evaluation is given to “dislike”. In this case, the user reaction extraction unit 25 sets “Chinese food” as an evaluation target because “Chinese food” is common in the context word and the recognition result. As described above, when a word common to the context word and the recognition result appears, the word is set as the evaluation target to evaluate the reaction of the user. In addition, the user reaction extraction unit 25 evaluates that the reaction of the user to “Chinese food” is negative from the polarity information given to the word “dislike” included in the recognition result. Further, it is sufficient to set a word that does not match with the context word included in the recognition result as the unevaluated context word without evaluation. In addition, similarly to a case where the word to which the polarity information is given is not included in the recognition result, the word which matches the context word included in the recognition result is not evaluated and may be set as the unevaluated context word.

For example, it assumed that the user informing is “Food that can be simply made will be good” with respect to the system informing “Which of Western food, Japanese food, and Chinese food is made?” and “simply” and “good” to which the positive polarity information is given are included in the word of the recognition result. In this case, the user reaction extraction unit 25 extracts “simply” as the context word from the context word candidate in the meta information context word candidate storage unit 17. Further, the reaction of the user to the context word “simply” is evaluated to be positive from the word “good”.

Examples of the extraction of the context word and the evaluation of the reaction of the user to the context word are merely examples.

Other context words to be extracted may include context word candidates that may be candidates according to the progress of the scenario, nouns that specify individuals such as proper nouns, and words related to advertisement genres that the scenario allows.

A context word candidate that may be a candidate for next user informing along the progress of the scenario will be described. For example, in the case where the user informing is “Chinese food is good, but other than spring roll”, when the context word candidate “spring roll” exists in the scenario context word candidate storage unit 16 and the meta information context word candidate storage unit 17, “spring roll” is extracted as the context word. In this case, the context word “spring roll” is evaluated to be negative by the word “other”.

A noun specifying an individual such as a proper noun will be described. For example, when a proper noun appearing in the user informing matches the context word candidate included in the scenario context word candidate storage unit 16 and the meta information context word candidate storage unit 17, the proper noun is extracted as the context word to be set as the evaluation target.

The word concerning the advertisement genre allowed by the scenario will be described. For example, the scenario relates to a recipe. In this case, when the keyword of the advertisement of which genre is “dish”, “dishware”, or the like matches the context word candidate included in the scenario context word candidate storage unit 16 and the meta information context word candidate storage unit 17, the keyword may be extracted as the context word to be set as the evaluation target.

As another method of the evaluation other than the method for indicating whether the context word is negative or positive, a method of evaluating whether the context word is negative or positive based on a similarity of the user informing to the system informing may be adopted. For example, the context word may be evaluated to be positive when the similarity of the user informing to the system informing is larger than a predetermined threshold and to be negative when the similarity of the user informing to the system informing is smaller than the predetermined threshold. Further, a speech emotion of the user informing may be identified by a known method in the related art and whether the context word is positive or negative may be evaluated according to the identified emotion.

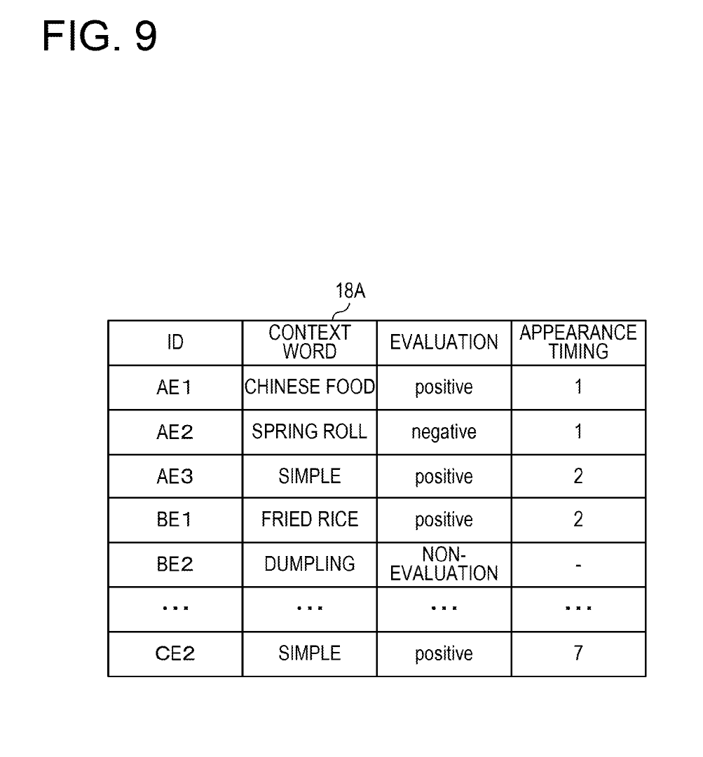

FIG. 9 illustrates an example of context word information 18A stored in a context word-specific user reaction information storage unit 18. The items of the table of the context word information 18A are constituted by the ID for identifying the context word, the context word, the evaluation of the response of the user to the context word, and appearance timing. The first record of the context word information 18A stores the context word “Chinese food”, the evaluation “positive”, and the appearance timing “1” in association with the ID “AE1”. The appearance timing indicates that at which portion of the scenario the context word included in the user informing or system informing is informed is recorded in the dialogue. The appearance timing “1” indicates that the context word relates to the user informing at a first set of the scenario. This is to determine when the context word which appears in the user informing appears because the word which does not appear in the user informing is also included as the context word. When the appearance timing is blank, the context word does not appear in the user informing. Further, the context word information 18A accumulated in the context word-specific user reaction information storage unit 18 is an example of a past context of the interaction of the disclosed technique, an input from the user expected in the future, and an output of the system scheduled in the future.

The advertisement determination unit 26 determines whether to insert the advertisement into the dialogue based on the determination result of the user informing of the user informing recognition unit 24 and a predetermined advertisement occurrence condition. For example, when the determination result matches the user informing condition, the advertisement determination unit 26 determines that the advertisement is not inserted and instructs the scenario progressing unit 21 to proceed to a next scenario. When the determination result does not match the user informing condition, the advertisement determination unit 26 determines that the advertisement is inserted when the determination result satisfies the advertisement occurrence condition. For example, when the number of times that the determination result does not match the user informing condition is counted three times or when the determination result does not match the user informing condition twice consecutively, a predetermined condition such as setting the number of times to 1 for 3 sets of the progress of the scenario or the like may be set.

When the advertisement determination unit 26 determines that the advertisement is inserted, the advertisement selection unit 27 selects the advertisement based on the attribute information on the advertisement stored in the advertisement data DB 30, the context word stored in the context word-specific user reaction information storage unit 18, and the evaluation for the context word.

An example of selection of the advertisement of the advertisement selection unit 27 will be described. For example, information such as a time during which the user and the system perform the dialogue, and an age, gender, a region, etc. of the user is accepted in advance and the advertisement of the advertisement data DB 30 is narrowed based on the information. Next, an advertisement having a keyword which matches the context word of which evaluation of the context word-specific user reaction information storage unit 18 is positive or is not made is extracted from the narrowed advertisement. Next, an advertisement having a keyword which matches the context word of which evaluation of the context word-specific user reaction information storage unit 18 is negative is deleted from the extracted advertisements. Then, the advertisement is randomly selected from the extracted and deleted advertisements. Further, the advertisement is not randomly selected, but an advertisement having a high score may be selected by adding a score to the number of times that the context word having the positive evaluation and the keyword match each other or a context word of which appearance timing is immediately latest. Further, when the advertisement is deleted, only the context words extracted from past interactions may be used among the context words of which evaluation is negative. Meanwhile, when extracting an advertisement, among the context words of which evaluation is positive, only the context word extracted from immediately latest user informing or system informing, or the user informing or system informing expected in the future may be used. As a result, when the dialogue deviates from the scenario, there is a high possibility that the advertisement which works toward returning the dialogue to the scenario may be presented.

The advertisement presenting unit 28 inserts the advertisement selected by the advertisement selection unit 27 as the system informing and presents the advertisement to the user during the dialogue. When there is a detailed advertisement in the presented advertisement, it is notified to the user informing recognition unit 24 that the contents of the advertisement include the detailed advertisement. In the recognition result returned from the user informing recognition unit 24, when the user is requesting presentation of the detailed advertisement, the detailed advertisement is presented. Further, when the presentation of the advertisement ends, the advertisement presenting unit 28 instructs the scenario progressing unit 21 to proceed with the scenario.

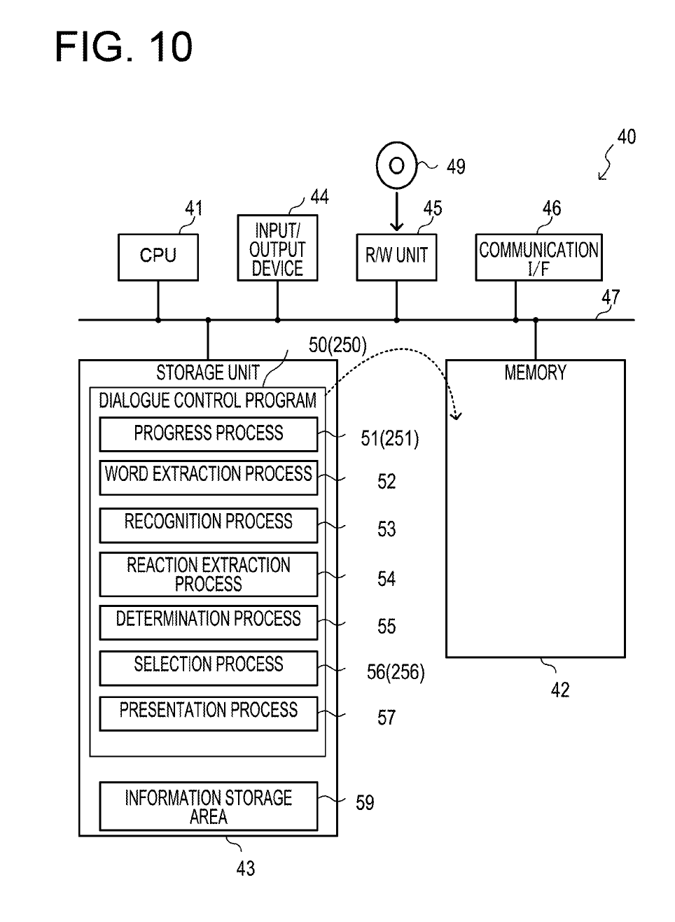

The dialogue control device 20 may be implemented by, for example, a computer 40 illustrated in FIG. 10. The computer 40 includes a central processing unit (CPU) 41, a memory 42 serving as a temporary storage region, and a non-volatile storage unit 43. Further, the computer 40 includes an input/output device 44, a read/write (R/W) unit 45 which controls reading and recording data from and in a storage medium 49, and a communication interface (I/F) 46 connected to the network, such as the Internet. The CPU 41, the memory 42, the storage unit 43, the input/output device 44, the R/W unit 45, and the communication I/F 46 are connected to each other via a bus 47.

The storage unit 43 may be implemented by a hard disk drive (HDD), a solid state drive (SSD), a flash memory, etc. The storage unit 43 as a storage medium stores a dialogue control program 50 which makes the computer 40 serve as the dialogue control device 20. The dialogue control program 50 includes a progress process 51, a word extraction process 52, a recognition process 53, a reaction extraction process 54, a determination process 55, a selection process 56, and a presentation process 57. Further, the storage unit 43 includes an information storage area 59 in which the scenario storage unit 15, the scenario context word candidate storage unit 16, the meta information context word candidate storage unit 17, and the context word-specific user reaction information storage unit 18 are maintained.

The CPU 41 reads the dialogue control program 50 from the storage unit 43, develops the read dialogue control program 50 to the memory 42, and sequentially executes the process of the dialogue control program 50. The CPU 41 executes the progress process 51 to operate as the scenario progressing unit 21 illustrated in FIG. 5. Further, by executing the word extraction process 52, the CPU 41 operates as the context word extraction unit 22 and the feature word extraction unit 23 illustrated in FIG. 5. In addition, the CPU 41 executes the recognition process 53 to operate as the user informing recognition unit 24 illustrated in FIG. 5. Further, the CPU 41 executes the reaction extraction process 54 to operate as the user reaction extraction unit 25 illustrated in FIG. 5. In addition, the CPU 41 executes the determination process 55 to operate as the advertisement determination unit 26 illustrated in FIG. 5. Further, the CPU 41 executes the selection process 56 to operate as the advertisement selection unit 27 illustrated in FIG. 5. In addition, the CPU 41 executes the presentation process 57 to operate as the advertisement presenting unit 28 illustrated in FIG. 5. Further, the CPU 41 extracts the information from the information storage area 59 and develops each of the scenario storage unit 15, the scenario context word candidate storage unit 16, the meta information context word candidate storage unit 17, and the context word-specific user reaction information storage unit 18 to the memory 42. As a result, the computer 40 that executes the dialogue control program 50 serves as the dialogue control device 20. Further, the CPU 41 that executes the program is hardware.

A function implemented by the dialogue control program 50 may be implemented by, for example, a semiconductor integrated circuit, more specifically, an application specific integrated circuit (ASIC), etc.

Subsequently, an operation of the dialogue control device 100 according to the embodiment will be described.

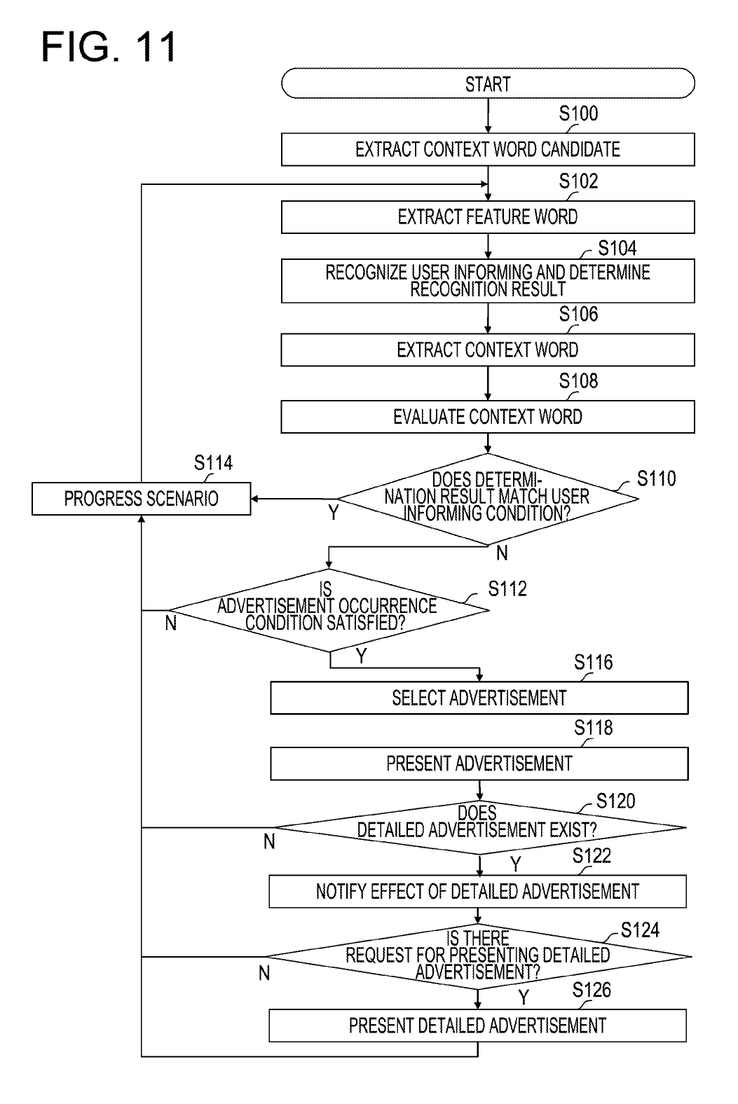

First, a dialogue control process will be described with reference to the flowchart of FIG. 11. When the scenario progressing unit 21 receives an instruction to start the dialogue from the user, the scenario progressing unit 21 acquires the scenario corresponding to the instruction from the scenario storage unit 15 and gives the first system informing of the acquired scenario to start the dialogue control processing. Further, when there is no response from the user for a predetermined period of time, the dialogue ends.

In operation S100, the context word extraction unit 22 acquires the dialogue scenario started from the scenario storage unit 15. The context word extraction unit 22 extracts a word which may appear in the dialogue from the system informing of the acquired scenario and the plurality of user informing conditions as the context word candidate and stores the corresponding word in the scenario context word candidate storage unit 16. Further, the context word extraction unit 22 extracts the context word candidate from the meta information given to the selected scenario and stores the extracted context word candidate in the meta information context word candidate storage unit 17.

In operation S102, the feature word extraction unit 23 extracts the feature word related to the system informing given by the progress of the dialogue based on the scenario context word candidate storage unit 16 and the meta information context word candidate storage unit 17, and outputs the extracted feature word to the user reaction extraction unit 25.

In operation S104, the user informing recognition unit 24 recognizes the user informing that is the response of the user to the system informing and outputs the recognition result to the user reaction extraction unit 25. Further, the user informing recognition unit 24 determines whether any one of the plurality of user informing conditions matches the recognition unit at a current point of time in the scenario, and outputs the determination result to the advertisement determination unit 26. In addition, the recognition result which includes polarity information indicating whether the word included in the user informing is an evaluation word is extracted.

In operation S106, the user reaction extraction unit 25 extracts the context word based on the feature word extracted in operation S102 and the recognition result of the user informing output in operation S104.

In operation S108, the user reaction extraction unit 25 evaluates the reaction of the user to the extracted context word in operation S106 based on the polarity information of the extracted recognition result, and stores the evaluated reaction in the context word-specific user reaction information storage unit 18.

In operation S110, the advertisement determination unit 26 determines whether the determination result of the user informing in operation S104 matches the user informing condition. When it is determined that the determination result matches the user informing condition, the process proceeds to operation S114. When the determination result does not match the user informing condition, the process proceeds to operation S112.

In operation S112, the advertisement determination unit 26 determines whether the user occurrence condition is satisfied. When it is determined that the advertisement occurrence condition is satisfied, the process proceeds to operation S116. When it is determined that the advertisement occurrence condition is not satisfied, the process proceeds to operation S114.

In operation S114, the scenario progressing unit 21 accepts an instruction to proceed to the next scenario from the advertisement determination unit 26 or the advertisement presenting unit 28 and performs the system informing of the next set of the scenario to progress the scenario so that the process proceeds to operation S102 to repeat the processing.

In operation S116, the advertisement selection unit 27 selects the advertisement based on the attribute information on the advertisement stored in the advertisement data DB 30, the context word stored in the context word-specific user reaction information storage unit 18, and the evaluation for the context word.

In operation S118, the advertisement presenting unit 28 inserts the advertisement selected in operation S116 as the system informing and presents the advertisement to the user during the dialogue.

In operation S120, the advertisement presenting unit 28 determines whether there is the detailed advertisement in the presented advertisement. When it is determined that there is the detailed advertisement, the process proceeds to operation S122 and when it is determined that there is no detailed advertisement, the process proceeds to operation S114.

In operation S122, the advertisement presenting unit 28 notifies the user informing recognition unit 24 that there is the detailed advertisement indicating the contents of the advertisement.

In operation S124, the advertisement presenting unit 28 determines whether the user is requesting presentation of the detailed advertisement in the recognition result returned from the user informing recognition unit 24. When it is determined that the user requests the presentation of the detailed advertisement, the process proceeds to operation S126 and when it is determined that the user does not request the presentation of the detailed advertisement, the process proceeds to operation S114.

In operation S126, the advertisement presenting unit 28 presents the detailed advertisement and the process proceeds to operation S114.

As described above, according to the dialogue control system of the embodiment, the advertisement related to the context word information extracted from the user informing and the dialogue scenario is selected from the advertisement of the advertisement data DB. The selected advertisement is inserted into the dialogue to be presented to the user. As a result, an appropriate advertisement depending on the context of the dialogue may be presented.

### Second Embodiment

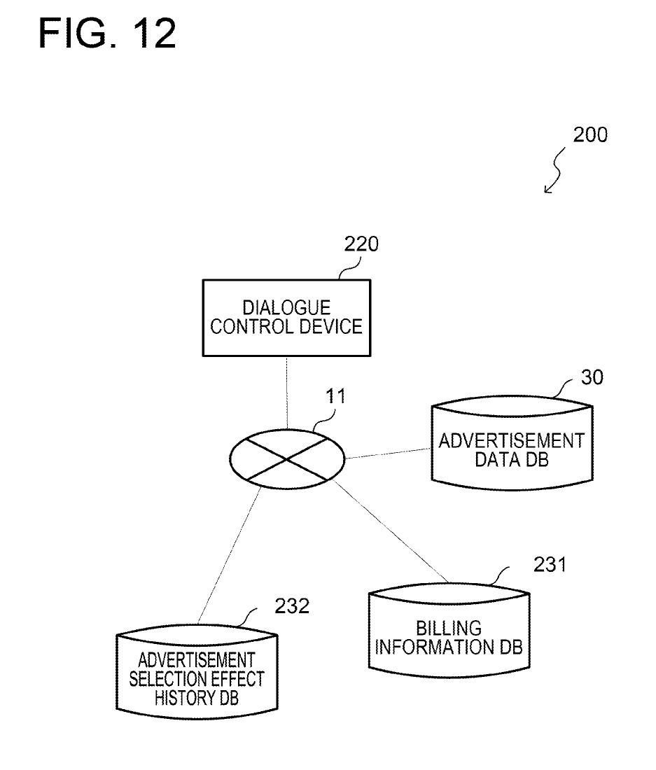

Next, a second embodiment of the present disclosure will be described. As illustrated in FIG. 12, a dialogue control system 200 according to the embodiment includes a dialogue control device 220, an advertisement data DB 30, a billing information DB 231, and an advertisement selection effect history DB 232. The dialogue control device 220, the advertisement data DB 30, the billing information DB 231, and the advertisement selection effect history DB 232 are connected via the network 11 such as the Internet. The dialogue control system 200 according to the second embodiment is different from the first embodiment in that the billing information DB 231 and the advertisement selection effect history DB 232 are provided as described above. Further, in FIG. 12, the same components as in the first embodiment illustrated in FIG. 4 are denoted by the same reference numerals as those in FIG. 4, and the description thereof is omitted.

The billing information DB 231 stores information on a billing amount of an advertisement expense for each advertiser who presents advertisement contents. For example, the information indicates that the billing amount for advertiser A is 20,000 yen, the billing amount for advertiser B is 60,000 yen, and the billing amount for advertiser C is 90,000 yen.

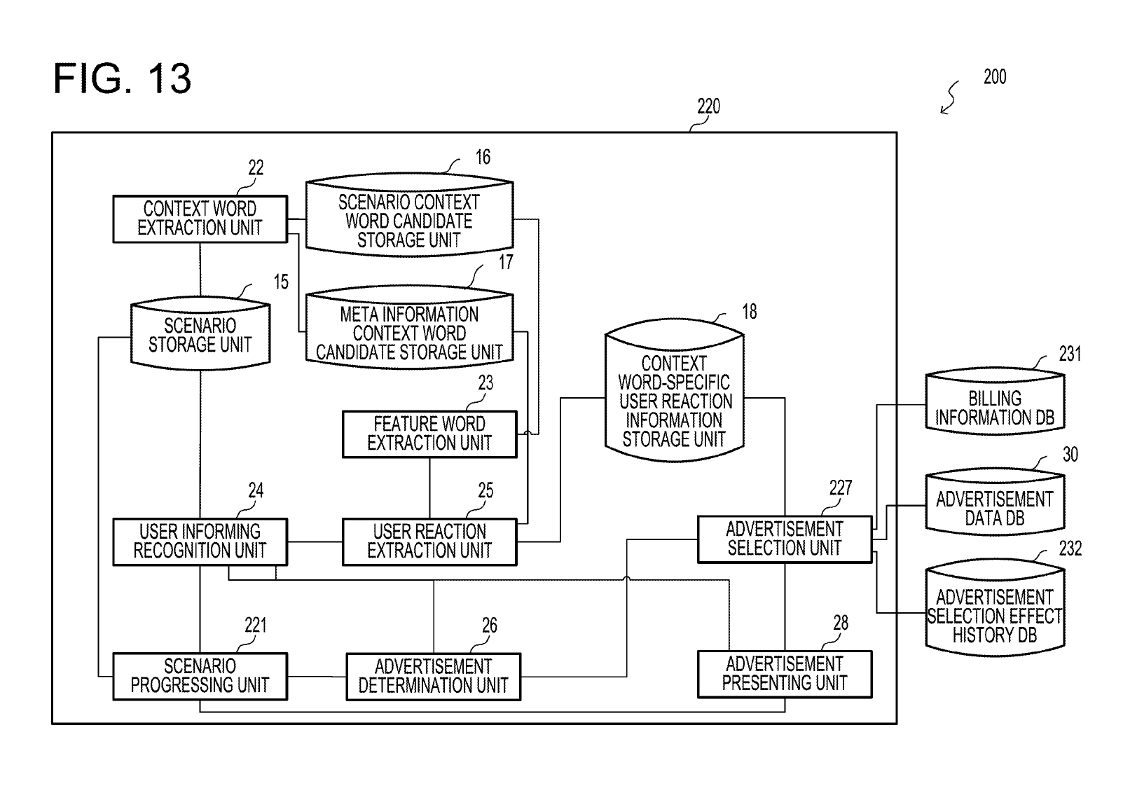

As illustrated in FIG. 13, the dialogue control device 220 is configured to include a scenario storage unit 15, a scenario context word candidate storage unit 16, a meta information context word candidate storage unit 17, and a context word-specific user reaction information storage unit 18. Further, the dialogue control device 220 is configured to include a scenario progressing unit 221, a context word extraction unit 22, a feature word extraction unit 23, a user informing recognition unit 24, a user reaction extraction unit 25, an advertisement determination unit 26, an advertisement selection unit 227, and an advertisement presenting unit 28. Further, in FIG. 13, the same components as in the first embodiment illustrated in FIG. 5 are denoted by the same reference numerals as those in FIG. 5, and the description thereof is omitted.

In addition to the processing of the scenario progressing unit 21 of the first embodiment, the scenario progressing unit 221 measures an advertisement selection effect history of the presented advertisement for each scenario and for each user, and stores the measured advertisement selection effect history in the advertisement selection effect history DB 232 for each advertisement. The advertisement selection effect history may be, for example, an advertisement effect indicating whether the advertisement is accepted by the user after presenting the advertisement. Further, the advertisement selection effect history may include a context affinity that indicates whether the dialogue is continued after presenting the advertisement. Further, the advertisement selection effect history may include a context inductivity that indicates whether a response for the advertisement is obtained from the user in the dialogue after presenting the advertisement. Further, the advertisement selection effect history does not need to include all of the advertisement effect, the context affinity, and the context inductivity, and may include at least one of the advertisement effect, the context affinity, and the context inductivity.

The advertisement effect is a rate at which the user informing is positive (e.g., “Tell me in detail”, “Tell me later”, etc.) for the advertisement presented by the advertisement presenting unit 28.

The context affinity is a rate at which the scenario is progressed without interruption of the dialogue after presenting the advertisement by the advertisement presenting unit 28. Whether the scenario is progressed may be determined based on whether the scenario is progressed in two sets or more after presenting the advertisement. Further, the context affinity may be a rate at which the scenario is progressed without interrupting the dialogue in the case where a positive user informing is not obtained in the advertisement effect.

The context inductivity is a rate at which a word related to the advertisement is included in the user informing with respect to the advertisement presented by the advertisement presenting unit 28. For example, when the advertisement is “Today is a special fish sale day at XX supermarket”, and the user informing is related to the word “fish” included in the advertisement such as “How much is saury?” or “A saurel is good”, it is assumed that the word related to the advertisement is included. The determination may be made by referring to, for example, a predetermined synonym dictionary, a related word dictionary, or the like.

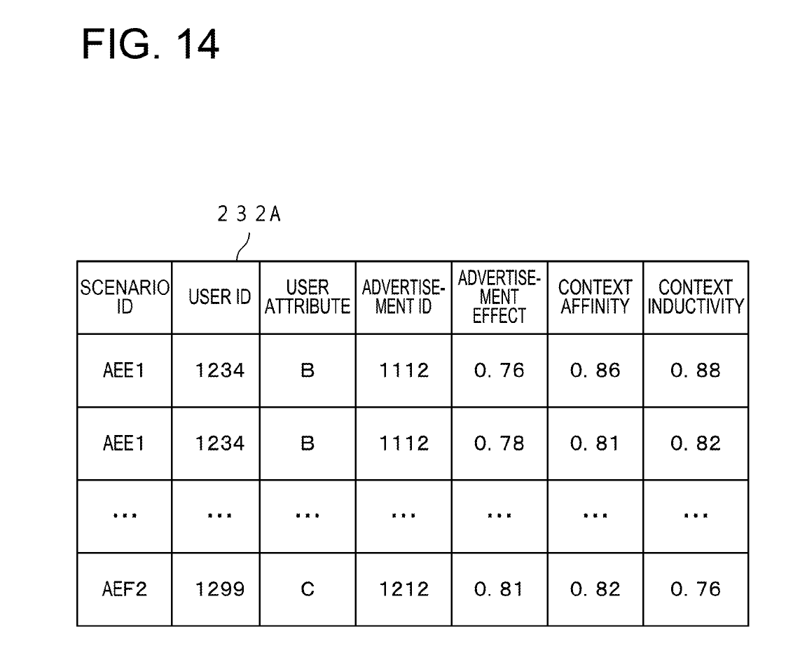

FIG. 14 illustrates an example of an advertisement selection effect history 232A stored in an advertisement selection effect history DB 232. The items of the advertisement selection effect history 232A are constituted by a scenario ID, a user ID, a user attribute, an advertisement ID, an advertisement effect, a context affinity, and a context inductivity. In the first record of the advertisement selection effect history 232A of FIG. 14, the scenario ID is “AEE1”, the user ID is “1234”, the user attribute is “B”, the advertisement ID is “1112”, the advertisement effect is “0.76”, the context affinity is “0.86”, and the context inductivity is “0.88”. Further, the advertisement selection effect history 232A may include, in addition to the items, a set number indicating a stage at which the scenario is or a word included in the user informing immediately before the advertisement is presented.

When determining that the advertisement is inserted by the advertisement determination unit 26, the advertisement selection unit 227 selects the advertisement based on the information stored in the billing information DB 231, the advertisement selection effect history DB 232, the advertisement data DB 30, and the context word-specific user reaction information storage unit 18.

Herein, a case in which the billing information DB 231 and the advertisement selection effect history DB 232, which are different from those of the first embodiment, are considered will be described.

When considering the contents of the billing information DB 231, the advertisement is selected with a probability according to the billing amount of the advertiser of the billing information DB 231. For example, a remaining number of times to present the advertisement of the advertiser in advance according to the billing amount is determined, and selected from the advertisement of the advertiser having the remaining number of times. For example, in the case of advertiser A, advertiser B, and advertiser C, the number of times for advertiser A may be set to 20, the number of times for advertiser B may be set to 50, and the number of times for advertiser C may be set to 100. After presenting the advertisement, the remaining number of times for the advertiser is reduced by one. Further, the billing amount is an example of cost of the disclosed technique.

In consideration of the advertisement selection effect history DB 232, for example, for each advertisement, a proportion of each of the advertisement effect, the context affinity, and the context inductivity is determined as a score for the scenario in progress of the dialogue, and an advertisement having a high score calculated by adding the score to each of the advertisement effect, the context affinity, and the context inductivity is selected. Further, the score may be calculated by narrowing to the user having the same attribute as the user in the dialogue.

The dialogue control device 220 may be implemented by, for example, the computer 40 illustrated in FIG. 10. The storage unit 43 of the computer 40 stores a dialogue control program 250 which makes the computer 40 serve as the dialogue control device 220. The dialogue control program 250 includes a progress process 251, a word extraction process 52, a recognition process 53, a reaction extraction process 54, a determination process 55, a selection process 256, and a presentation process 57. Further, the storage unit 43 includes an information storage area 59 in which the scenario storage unit 15, the scenario context word candidate storage unit 16, the meta information context word candidate storage unit 17, and the context word-specific user reaction information storage unit 18 are maintained.

The CPU 41 reads the dialogue control program 250 from the storage unit 43, develops the read dialogue control program 250 to the memory 42, and sequentially executes the process of the dialogue control program 250. The CPU 41 executes the progress process 251 to operate as the scenario progressing unit 221 illustrated in FIG. 13. Further, by executing the word extraction process 52, the CPU 41 operates as the context word extraction unit 22 and the feature word extraction unit 23 illustrated in FIG. 13. In addition, the CPU 41 executes the recognition process 53 to operate as the user informing recognition unit 24 illustrated in FIG. 13. Further, the CPU 41 executes the reaction extraction process 54 to operate as the user reaction extraction unit 25 illustrated in FIG. 13. In addition, the CPU 41 executes the determination process 55 to operate as the advertisement determination unit 26 illustrated in FIG. 13. Further, the CPU 41 executes the selection process 256 to operate as the advertisement selection unit 227 illustrated in FIG. 13. In addition, the CPU 41 executes the presentation process 57 to operate as the advertisement presenting unit 28 illustrated in FIG. 13. Further, the CPU 41 reads the information from the information storage area 59 and develops each of the scenario storage unit 15, the scenario context word candidate storage unit 16, the meta information context word candidate storage unit 17, and the context word-specific user reaction information storage unit 18 to the memory 42. As a result, the computer 40 that executes the dialogue control program 250 serves as the dialogue control device 220. Further, the CPU 41 that executes the program is hardware.

A function implemented by the dialogue control program 250 may be implemented by, for example, a semiconductor integrated circuit, more specifically, an ASIC, etc.

Subsequently, an operation of the dialogue control system 200 according to the embodiment will be described. Meanwhile, the same reference numerals refer to parts having the same functions as those of the first embodiment and the description of the same parts having the same functions will be omitted.

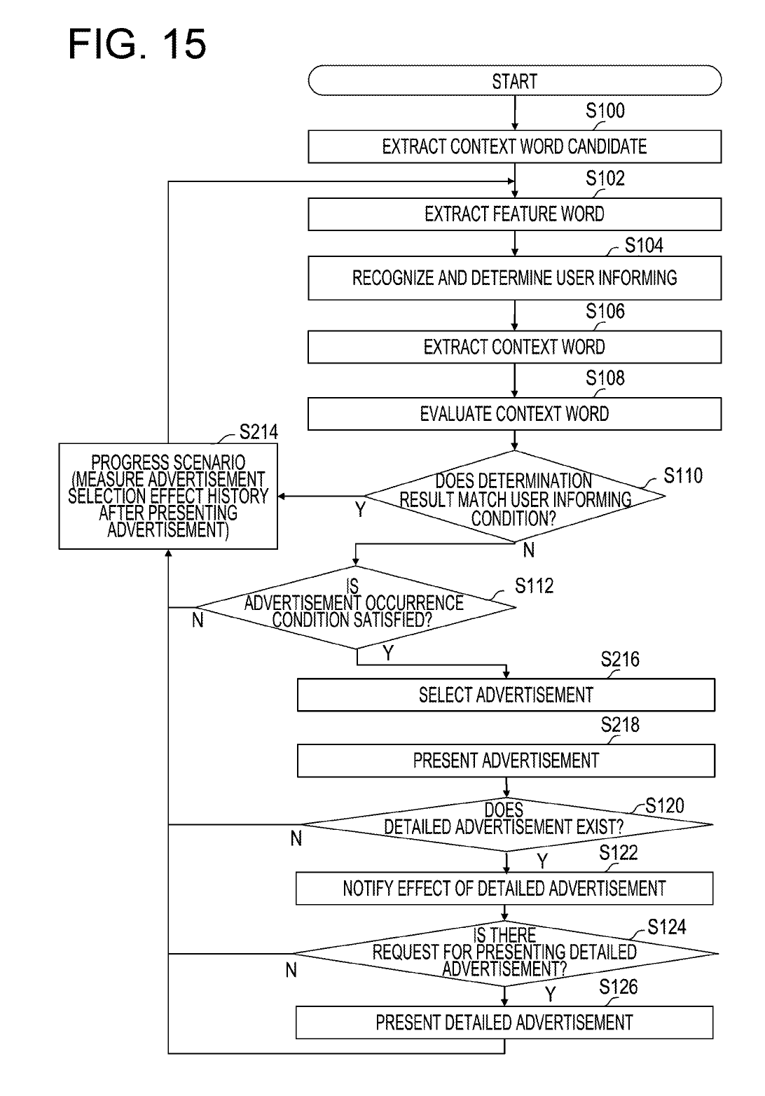

As illustrated in FIG. 15, in operation S214, the scenario progressing unit 221 accepts an instruction to proceed to the next scenario from the advertisement determination unit 26 or the advertisement presenting unit 28 and performs the system informing of the next set of the scenario to progress the scenario so that the process proceeds to operation S102 to repeat the processing. Further, after presenting the advertisement, the advertisement selection effect history of the presented advertisement is measured and stored for the user of the scenario under the dialogue.

In operation S216, the advertisement selection unit 227 selects the advertisement based on the information stored in the billing information DB 231, the advertisement selection effect history DB 232, the advertisement data DB 30, and the context word-specific user reaction information storage unit 18.

According to the dialogue control system of the embodiment, the advertisement related to the context word information extracted from the user informing and the dialogue scenario is selected from the advertisement of the advertisement data DB. The selected advertisement is inserted into the dialogue to be presented to the user. The advertisement selection effect history is measured for each user and used for selecting the advertisement. To this end, it is possible to present an appropriate advertisement which follows the context of the dialogue and increases the advertisement effect for each user.

In each of the above-described embodiments, the case that the dialogue control device provides a dialogue service is described, but the present disclosure is not limited thereto. For example, the dialogue service may be provided in an application operating on a user terminal connected to the dialogue control device via the network. The user terminal may be implemented by a personal computer, a tablet terminal, a smart phone, or the like.

Although it is described that the supplementary information is the advertisement, the supplementary information is not limited thereto and may be other information such as news according to the context of the dialogue.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A dialogue control system comprising:
a memory; and
a processor coupled to the memory and the processor configured to:
select, from a supplementary information candidate, supplementary information related to at least one of a past context of an interaction including an input from a user and a predetermined output of the dialogue control system with respect to the input from the user, an input of the user expected in future in association with the output of the dialogue control system, and an output of the dialogue control system scheduled in the future; and
insert the selected supplementary information into the interaction and present the inserted supplementary information to the user.

2. The dialogue control system according to claim 1,
wherein the processor is further configured to:
determine whether to present the supplementary information based on the input from the user in the interaction, and
wherein when it is determined that the supplementary information is presented, the processor is configured to insert the selected supplementary information into the interaction and present the inserted supplementary information to the user.

3. The dialogue control system according to claim 1,
wherein the processor is further configured to:
extract information on a reaction of the user for first information on the output of the dialogue control system or the presented supplementary information based on the input from the user, and
wherein the processor is configured to select the supplementary information based on the extracted information on the reaction of the user.

4. The dialogue control system according to claim 3,
wherein the processor is configured to
extract the supplementary information including a negative reaction of the user for the first information as the information on the reaction of the user, and
select the supplementary information from the supplementary information candidate except for the supplementary information candidate corresponding to the first information from which the negative reaction of the user is extracted.

5. The dialogue control system according to claim 3,
wherein the processor is further configured to:
record the reaction of the user to the presented supplementary information for each user, and
wherein the processor is configured to select the supplementary information from the supplementary information candidate based on the recorded reaction of each user to the supplementary information.

6. The dialogue control system according to claim 5,
wherein the processor is configured to
record at least one of a supplementary information effect indicating whether the supplementary information is accepted by the user after presenting the supplementary information, a context affinity indicating whether the interaction is continued after presenting the supplementary information, and a context inductivity indicating whether the reaction for the supplementary information is obtained from the user in the interaction after presenting the supplementary information as the reaction of the user to the supplementary information for each user, and
select the supplementary information from the supplementary information candidate based on at least one of the supplementary information effect, the context affinity, and the context inductivity.

7. The dialogue control system according to claim 1,
wherein the processor is configured to change a proportion for selecting the supplementary information in accordance with a selection probability determined depending on predetermined cost with respect to the supplementary information candidate.

8. A computer-readable non-transitory recording medium storing a program that causes a computer to execute a procedure of a dialogue control system, the procedure comprising:
selecting, from a supplementary information candidate, supplementary information related to at least one of a past context of an interaction including an input from a user and a predetermined output of the dialogue control system with respect to the input from the user, an input of the user expected in future in association with the output of the dialogue control system, and an output of the dialogue control system scheduled in the future; and
inserting the selected supplementary information into the interaction and present the inserted supplementary information to the user.

9. The computer-readable non-transitory recording medium according to claim 8, the procedure further comprising:
determining whether to present the supplementary information based on the input from the user in the interaction,
wherein when it is determined that the supplementary information is presented, the procedure inserts the selected supplementary information into the interaction and presents the inserted supplementary information to the user.

10. The computer-readable non-transitory recording medium according to claim 8, the procedure further comprising:
extracting information on a reaction of the user for first information on the output of the dialogue control system or the presented supplementary information based on the input from the user,
wherein the procedure selects the supplementary information based on the extracted information on the reaction of the user.

11. The computer-readable non-transitory recording medium according to claim 10,
wherein the procedure extracts the supplementary information including a negative reaction of the user for the first information as the information on the reaction of the user, and selects the supplementary information from the supplementary information candidate except for the supplementary information candidate corresponding to the first information from which the negative reaction of the user is extracted.

12. The computer-readable non-transitory recording medium according to claim 10, the procedure further comprising:
recording the reaction of the user to the presented supplementary information for each user,
wherein the procedure selects the supplementary information from the supplementary information candidate based on the recorded reaction of each user to the supplementary information.

13. The computer-readable non-transitory recording medium according to claim 12,
wherein the procedure
records at least one of a supplementary information effect indicating whether the supplementary information is accepted by the user after presenting the supplementary information, a context affinity indicating whether the interaction is continued after presenting the supplementary information, and a context inductivity indicating whether the reaction for the supplementary information is obtained from the user in the interaction after presenting the supplementary information as the reaction of the user to the supplementary information for each user, and
selects the supplementary information from the supplementary information candidate based on at least one of the supplementary information effect, the context affinity, and the context inductivity.

14. A dialogue control method of a dialogue control system comprising:
selecting, from a supplementary information candidate, supplementary information related to at least one of a past context of an interaction including an input from a user and a predetermined output of the dialogue control system with respect to the input from the user, an input of the user expected in future in association with the output of the dialogue control system, and an output of the dialogue control system scheduled in the future; and
inserting the selected supplementary information into the interaction and present the inserted supplementary information to the user, by a processor.

15. The dialogue control method according to claim 14, further comprising:
determining whether to present the supplementary information based on the input from the user in the interaction,
wherein when it is determined that the supplementary information is presented, the processor inserts the selected supplementary information into the interaction and present the inserted supplementary information to the user.

16. The dialogue control method according to claim 14, further comprising:
extracting information on a reaction of the user for first information on the output of the dialogue control system or the presented supplementary information based on the input from the user,
wherein the processor selects the supplementary information based on the extracted information on the reaction of the user.

17. The dialogue control method according to claim 16,
wherein the processor
extracts the supplementary information including a negative reaction of the user for the first information as the information on the reaction of the user, and
selects the supplementary information from the supplementary information candidate except for the supplementary information candidate corresponding to the first information from which the negative reaction of the user is extracted.

18. The dialogue control method according to claim 16, further comprising:
recording the reaction of the user to the presented supplementary information for each user,
wherein the processor selects the supplementary information from the supplementary information candidate based on the recorded reaction of each user to the supplementary information.

19. The dialogue control method according to claim 18,
wherein the processor
records at least one of a supplementary information effect indicating whether the supplementary information is accepted by the user after presenting the supplementary information, a context affinity indicating whether the interaction is continued after presenting the supplementary information, and a context inductivity indicating whether the reaction for the supplementary information is obtained from the user in the interaction after presenting the supplementary information as the reaction of the user to the supplementary information for each user, and
selects the supplementary information from the supplementary information candidate based on at least one of the supplementary information effect, the context affinity, and the context inductivity.

20. The dialogue control method according to claim 14,
wherein the processor changes a proportion for selecting the supplementary information in accordance with a selection probability determined depending on predetermined cost with respect to the supplementary information candidate.
